(19) United States
(12) Patent Application Publication
(10) Pub. No.: US 2010/0158318 A1
(43) Pub. Date: Jun. 24, 2010

(54) FOCAL SPOT SIZE MEASUREMENT WITH A MOVABLE EDGE LOCATED IN A BEAM-SHAPING DEVICE

(75) Inventor: Rudolph Maria Snoeren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,316

(22) PCT Filed: Jul. 23, 2007
(86) PCT No.: PCT/IB07/52917

§ 371 Date: Feb. 4, 2009

(30) Foreign Application Priority Data
Aug. 9, 2006 (EP) 06118656.5

(51) Int. Cl. G06K 9/62

(52) U.S. Cl. 382/106

(57) ABSTRACT

It is described a method for measuring the sharpness in an X-ray system (100). The measurement is based on a common edge response. An edge device (120) representing the projection device is placed within a beam-shaping device (470). Due to a high geometrical magnification factor the edge response function (241a) and also both an impulse response function (246a) and a modulation transfer function (251a) will predominately depend on the size of the focal spot (112) rather than on a pre-sampling spread function of a detector (130) being used for receiving the X-radiation (117), which has laterally passed the edge device (120).

The present invention generally relates to the field of X-ray imaging. In particular, the present invention relates to a method for determining the spatial distribution of a focal spot of an X-ray tube, which focal spot is generated by electrons impinging onto the surface of an anode of the X-ray tube.

The present invention further relates to a data processing device and to a medical X-ray imaging apparatus for determining the spatial distribution of a focal spot of an X-ray tube.

Furthermore, the present invention relates to a computer-readable medium and to a program element having instructions for executing the above-mentioned method for determining the spatial distribution of a focal spot of an X-ray tube.

The shape and the dimension of a focal spot of an X-ray tube is an important parameter for X-ray imaging. A blurred focal spot causes an unsharpness of an X-ray image being recorded by means of X-rays originating from an enlarged focal spot area. Therefore, in order to provide for high quality X-ray images, a knowledge of the focal spot dimensions is important for estimating the quality of an X-ray system.

A multitude of methods exist for the determination of the focal shape of an X-ray tube. The majority of the methods use a pinhole at a given distance of the X-ray target, such that an enlarged image of the focus is projected onto a detector or a sheet of film. The pinhole method is frequently used as a performance indicator of an X-ray tube.

Another method for determining the focal spot area is the use of a so-called star-burst pattern as an object located at some distance of the tube. The star-burst pattern comprises a plurality of heavily X-ray absorbing sectors of a circle, which are arranged within a circle in a symmetric manner. Since the spatial distance between two neighboring sectors decreases when approaching the center of the circle, the spatial resolution of a X-ray imaging system is given by a radial distance of the center, at which radial distance bright and dark sectors can still be optically resolved. The reciprocal of the spatial frequency within the image of the star-burst, at which frequency a phase-inversion occurs, provides the effective width of the focal blurring at a certain angular position of the star-burst. This width can be measured on a monitor and, by a proper scaling, the real dimensions of the focal spot can be determined.

The publication “Generalizing the MTF and DQE to include a X-ray scatter and focal spot unsharpness: Application to a new microangiographic system, Iacovos S. Kyprianou et al., Med. Phys. 32 (2), February 2005, Am. Assoc. Phys. Med” discloses the use of an edge response for determining the dimension of a focal spot. Thereby, a modulation transfer function (MTF) is used for determining the spatial frequency of an X-ray image, which allows for a determination of the focal blurring in the frequency domain.

DE 101 395 00 discloses a method for determining the position of a focal spot within an X-ray tube. The method uses a test absorber located in an X-ray source housing, which test absorber can be brought into a reproducible measurement position with reference to the focal spot. The test absorber comprises an X-ray absorbing structure, which structure can be seen as an X-ray pattern on an X-ray receiver. The determination of the position of the focal spot is carried out with a sophisticated image processing method.

EP 1 369 084 A1 discloses an edge phantom for assessing the sharpness response of a radiation image recording and detection system. The edge phantom is subjected to radiation emitted by a source of radiation to generate a radiation image and wherein the radiation image, recorded and detected by the system, is evaluated. The design of the edge phantom provides that a curved lateral surface of the phantom contains straight lines each comprising to focus point of the source of radiation. The disclosed phantom has the disadvantage, that due to a complicated surface structure, a manufacturing of the phantom is rather complicated.

There may be a need for providing a method for determining the size of a focal spot of an X-ray tube, which method does not require a phantom being formed in a complicated manner and which method comprises a comparatively quick and easy image processing.

This need may be met by the subject matter according to the independent claims. Advantageous embodiments of the present invention are described by the dependent claims.

According to a first aspect of the invention there is provided a method for determining the spatial dimension of a focal spot of an X-ray tube, which focal spot is generated by electrons impinging onto the surface of an anode of the X-ray tube. The provided method comprises the steps of (a) generating an X-ray beam originating from the focal spot, (b) moving an X-ray attenuating edge device into the X-ray beam to a predetermined position, (c) measuring an edge response function based on a shadowing effect of the edge device by means of an X-ray detector having a spatial resolution, and (d) analyzing the edge response function. Thereby, the edge device is located within an X-ray beam-shaping device, which beam-shaping device is associated with the X-ray tube.

This aspect of the invention is based on the idea that the described method may be carried by using a beam-shaping device, which is existent anyway in common known X-ray imaging systems. This may provide the advantage that the described focal size measurement method for determining the spatial dimension of a focal spot may be carried out without requiring larger modifications to present available X-ray imaging systems.

The X-ray attenuating edge may be any absorbing object with preferably a sharp edge. When the edge device is placed within the X-ray beam a focal spot of finite size projects a shadow image of the preferably heavily absorbing edge device onto the X-ray detector. The spatial resolving X-ray detector will measure a transitional region of the X-ray intensity. Thereby, a transition from a deepest shadow via a penumbra region to a fully X-ray illuminated region will be observed. The transitional region contains information about the focus size.

By orienting the edge device along different directions preferably perpendicular to the optical axis of the X-ray beam also information regarding the special shape of the focal spot may be extracted by evaluating the course of different transitional regions. Therefore, the described method not only allows for determining of the overall size of the focal spot, the described method rather allows for extracting information of the focal spot size along a direction being perpendicular to the edge device. This means, that, when the described method is carried out a couple of times wherein the orientation of the edge device is changed sequentially, the expansion of a focal spot may be measured along different directions. This allows for an in particular precise determination of the two-dimensional elongation of the focal spot.

An advantage of the availability of the edge device in the beam-shaper is the matter of fact that the edge device may be located close to the X-ray tube. This has the effect that a relatively high magnification of the edge response is achieved. This in turn has the advantage that the edge response is determined almost entirely by the focal shape and to a negligible extent by the so-called detector pre-sampling spread function, which actually denotes the sampling aperture. Therefore, even very small changes in the focal shape can be detected. In other words, the edge device being located close to the focal spot, almost entirely gives out the focal spot response and to a negligible or correctible extent the detector response.

According to an embodiment of the invention the X-ray detector is a two-dimensional detector. This may provide the advantage that the described focal size measurement method may be applied to a variety of different X-ray imaging systems comprising an X-ray tube and any flat X-ray detector. By contrast to an X-ray detection device using an X-ray image intensifier, a flat X-ray detector comprises a two dimensional photo diode array, which is covered with an X-ray sensitive layer. Thereby, the X-ray sensitive layer converts the X-ray photons into light, which has an appropriate energy range such that the light can be detected by diodes. However, also X-ray detectors may be employed providing for a direct conversion of X-ray photons into charge carriers, which can be detected by an electronic sensor array.

The X-ray detector may be the same detector which is used also for X-ray imaging. Therefore, the X-ray detector may comprise a plurality of detector pixel elements providing for the spatial resolution of the detector.

Further, the edge response function may be recorded as an average of a plurality of different edge responses across the edge device, whereby the different edge responses correspond to pixel lines being shifted with respect to each other along a direction parallel to the edge.

It has to be mentioned that the described method may not only be applied for two-dimensional X-ray imaging systems. Since the sharpness of X-ray images is also an important parameter for computed tomography (CT) systems, a focal spot size measurement method may be also very useful for an X-ray tube being used for CT. Of course, also X-ray tubes used for C-arm systems may be calibrated regarding the size of the focal spot.

According to a further embodiment of the invention the step of measuring an edge response function comprises recording the total intensity of X-rays impinging onto at least a plurality of pixel elements of the X-ray detector by integrating the signals of these pixel elements. The integration respectively the summation of these detector signals may provide the advantage that due to an increased photon statistic the noise of edge response function is reduced significantly.

According to a further embodiment of the invention the method further comprises calculating an impulse response function representing the derivative of the edge response function. This may provide the advantage that instead of directly analyzing the edge response function a more structured function can be evaluated in order to precisely determine the focal spot size. Therefore, a more precise focal spot size determination can be achieved.

According to a further embodiment of the invention the method further comprises calculating a modulation transfer function representing the Fourier transform of the impulse response function. The modulation transfer function (MTF) allows for a very precise determination of the focal spot size. Thereby, the first zero crossing of the MTF is typically a reliably indication for the focal spot size. In this respect it has to be mentioned that when using the MTF the contrast of the whole X-ray system should be set to a linear mode and not to e.g. a logarithmic scale, because the MTF is solely defined in a linear signal regime.

Preferably, the calculated modulation transfer function represents the absolute values of the Fourier transform of the impulse response function. This makes a processing and evaluating of the MTF rather easy.

According to a further embodiment of the invention the method further comprises (a) again moving the X-ray attenuating edge device into the X-ray beam to a further predetermined position, (b) measuring a further edge response by means of the X-ray detector. This has the advantage that the edge response may be measured in various positions within the X-ray beam. This make the analysis of the averaged edge response much more precise such that also very small changes in the focal spot size can be identified.

According to a further embodiment of the invention the beam-shaping device is adapted to laterally limit the dimension of the X-ray beam. This has the advantage that the edge device may be implemented within a device for spatially shaping the X-radiation being emitted from the X-ray tube. Such a device is present in almost any type of X-ray imaging system in order to spatially restrict the lateral dimension of an X-radiation beam. The beam-shaping device typically comprises an aperture system, wherein a diaphragm or a shiftable baffle system is provided in order to shape the cross section of the radiation beam. In case of a medical X-ray imaging system such a device for spatially shaping respectively restricting the X-ray beam size is used to effectively limit the X-ray exposure to a defined region of a patient, which region is subjected to an X-radiation dose.

According to a further embodiment of the invention the beam-shaping device is adapted to modify the spectral distribution of the X-ray beam being emitted from the X-ray tube. Typically, such a spectral beam-shaping device is used for removing or at least reducing the number of X-ray photons within the lower energy range of the whole X-ray energy distribution. In particular in medical X-ray imaging such low energy photons do not or do only weakly contribute to the X-ray imaging whereas they contribute significantly to the overall radiation dose a patient is exposed. Therefore, a removal of these low energy photons makes the whole X-ray imaging more effective.

The spectral beam-shaping may be carried out by inserting a spectral depending filter element into the X-ray beam. Such a filter element is typically a metal plate made e.g. from copper and/or aluminum. The thickness of such copper plate typically ranges in between 0.1 mm and 1 mm. In order to mechanically stabilize such a thin copper plate the copper plate may be attached to an aluminum plate having a thickness of e.g. 1 mm. Of course, the plate can also be made from a copper/aluminum alloy. Further, the plate can also comprise different thicknesses or layers having different thicknesses.

According to a further embodiment of the invention the edge device is a spectral filter element. This means that the filter element is adapted to modify the spectral distribution of the X-ray beam being emitted from the X-ray tube. As has already been mentioned above, such a filter element may be a metal plate made e.g. from copper and/or aluminum.

It has to be pointed out that an almost 1 mm thick copper plate represents a rather strong absorber for X-radiation in particular if a low acceleration voltage is used for electrons impinging onto the anode surface. A low acceleration voltage in the order of 40 to 60 kV has the advantage, that already typical filter elements, which are usually employed to modify the spectral distribution of the X-rays, may be used as a heavily absorbing filter element having a sharp edge. Therefore, the described method may be carried out with common known beam-shaping devices without making any mechanical modifications necessary. Depending on the X-ray attenuation properties of the filter, the acceleration voltage of the X-ray tube may be temporarily reduced when the described method for determining the spatial distribution of the focal spot is carried out. In this respect it has to be mentioned that the shape and/or the dimension of the focal spot typically does not depend strongly on the acceleration voltage such that the measured focal spot dimension are in a good approximation also valid for a higher acceleration voltage, which is applied during a normal operation of the X-ray tube.

Preferably, the spectral X-ray filter element is introduced in or at a holder. Such a type of holder, which is commonly used in beam-shaping devices, is adapted to receive or accommodate a spectral filter element.

According to a further embodiment of the invention the edge device is accommodated or attached to a turret. This has the advantage that a movement of the edge device into at least one predefined position within the X-ray beam may be accomplished by a simple mechanical rotation of the turret around a rotational axis being shifted with respect to the optical axis of the X-ray beam. Compared to a linear movement a rotational movement may be realized from the mechanical point of view in a much more easy manner.

It has to be pointed out that depending on the orientation of the edge device relative to an x-y coordinate system the size of the focal spot along different direction may be determined. In particular, if the edge is oriented at an angle of approximately 45° with respect to the x-axis, the average response between the x-direction and the y-direction is determined. In other words, a slanted angle of 45° allows the determination of an edge response function representing the average between a first edge response function along the x-axis and a second edge response function along the y-axis. Preferably, the axes are defined with respect to the detector orientation.

It has to be mentioned that of course the coordinate basis of the edge response functions can be changed by simply rotating back the image obtained by a deliberately slanted edge. Of course, the rotation can be carried out by means of software such that a signal integration parallel to the edge of the edge device can be carried out in order to increase the signal to noise ratio of the edge response function.

According to a further embodiment of the invention the edge device comprises a first edge and a second edge, wherein the first edge is oriented slanted with respect to the second edge. Provided that an appropriate positioning system is available for moving the edge device into at least two different predetermined positions such that different edge orientations are provided, this has the advantage that the focal spot size may be measured independently along the two different directions.

Preferably, the first edge and the second edge are oriented perpendicular with respect to each other. This may provide the advantage that separate edge response functions may be determined for the x-direction and for the y-direction. Of course, this requires a positioning system allowing for an independent positioning of both the edge extending along the x-direction along the y-direction and the edge extending along the y-direction along the x-direction.

It has to be mentioned that if a separate position is available in the turret, the edge material can freely be chosen. Thereby, heavily X-ray absorbing materials such as Tungsten would be appropriate.

According to a further aspect of the invention there is provided a data processing device for determining the spatial dimension of a focal spot of an X-ray tube. The data processing device comprises (a) a data processor, which is adapted for performing exemplary embodiments of the above-described method, and (b) a memory for storing at least one recorded edge response function.

According to a further aspect of the invention there is provided a medical X-ray imaging apparatus. The medical X-ray imaging apparatus may be e.g. a computed tomography scanner or a C-arm system. The medical X-ray imaging apparatus comprises the above-described data processing device.

According to a further aspect of the invention there is provided a computer-readable medium on which there is stored a computer program for determining the spatial dimension of a focal spot of an X-ray tube. The computer program, when being executed by a data processor, is adapted for performing exemplary embodiments of the above-described methods.

According to a further aspect of the invention there is provided a program element for determining the spatial dimension of a focal spot of an X-ray tube. The program element, when being executed by a data processor, is adapted for performing exemplary embodiments of the above-described methods.

The computer program element may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or other programmable device to carry out the intended functions. The computer program may be available from a network, such as the WorldWideWeb, from which it may be downloaded.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered to be disclosed with this application.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

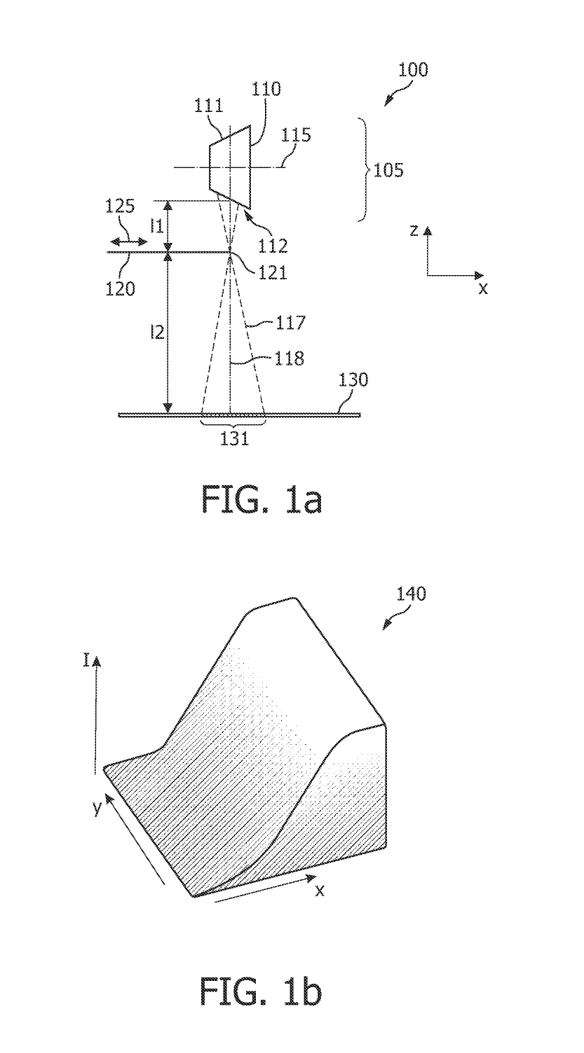

FIG. 1a shows a schematic representation of a medical X-ray imaging apparatus when carrying out a method according to an embodiment of the invention.

FIG. 1b shows a three-dimensional representation of an edge response function for determining the size of a focal spot of an X-ray tube.

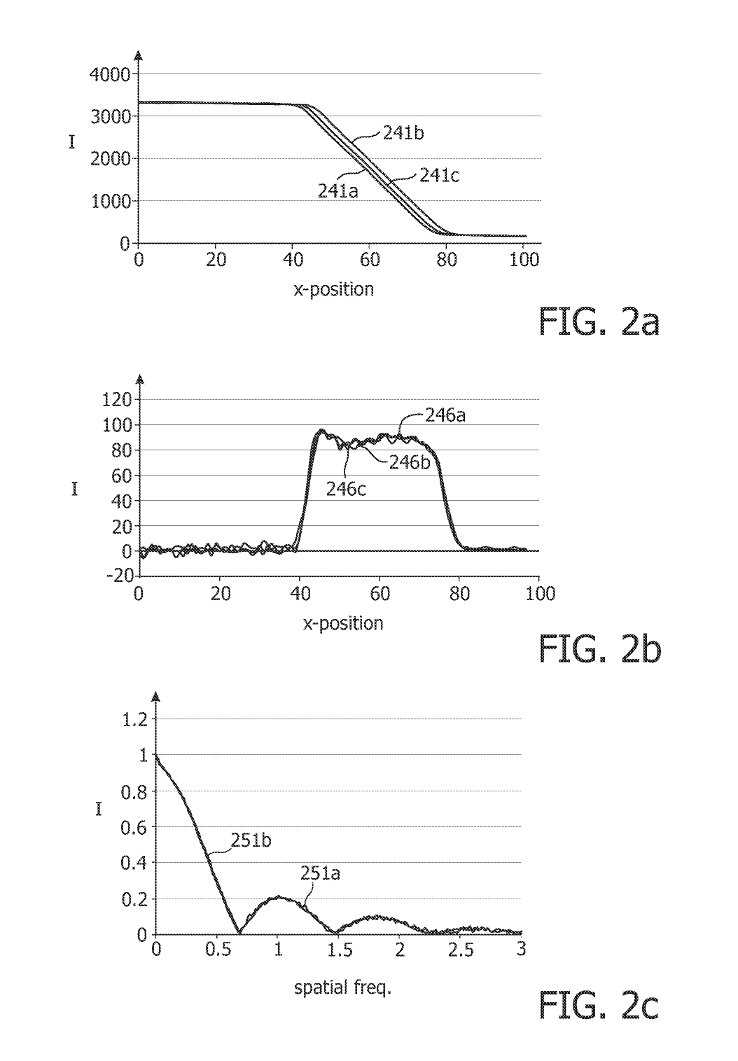

FIG. 2a shows a diagram depicting edge response functions.

FIG. 2b shows a diagram depicting impulse response functions of the edge response functions shown in FIG. 2a.

FIG. 2c shows a modulation transfer function obtained from the impulse response functions shown in FIG. 2b.

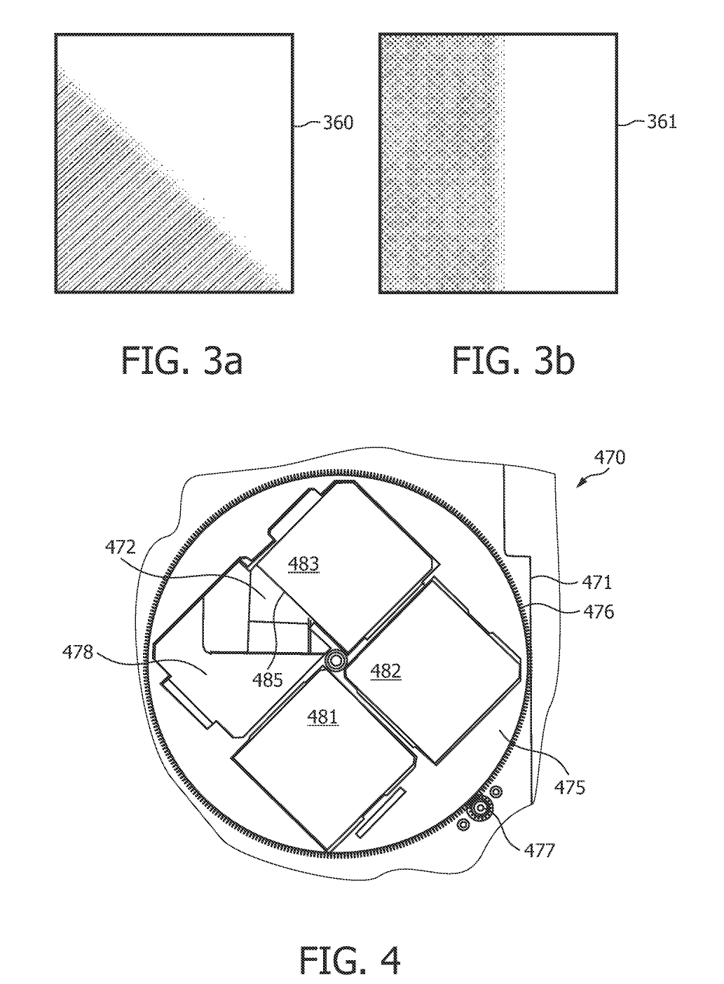

FIG. 3a shows an X-ray image of a deliberately slanted edge.

FIG. 3b shows the X-ray image depicted in FIG. 3a, which X-ray image has been rotated back by 45°.

FIG. 4 shows a part of a beam-shaping device, which is equipped with a spectral filter element having a movable edge for recording an edge response function.

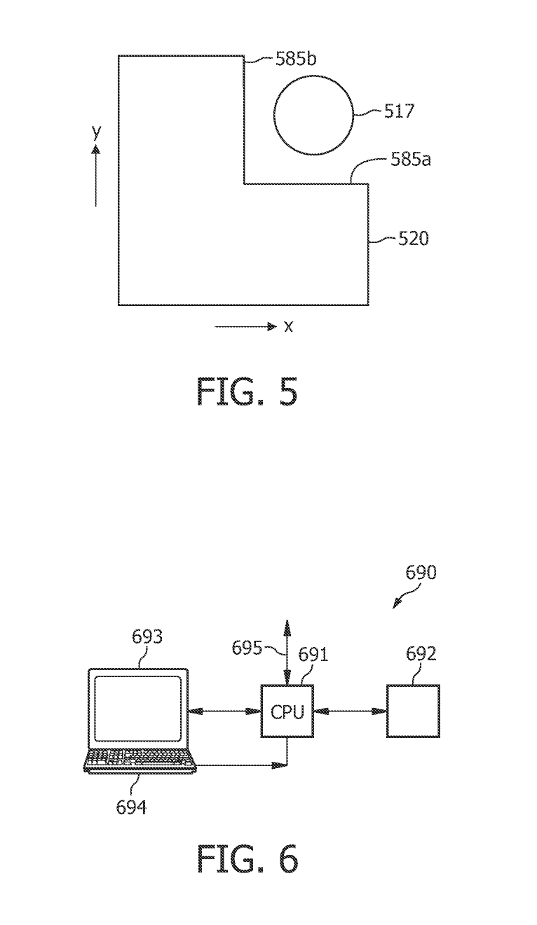

FIG. 5 shows an edge device having two edges for recording two edge response functions along different directions.

FIG. 6 shows a data processing device, which is adapted to perform a focal spot size determination.

The illustration in the drawing is schematically. It is noted that in different figures, similar or identical elements are provided with the same reference signs or with reference signs, which are different from the corresponding reference signs only within the first digit.

FIG. 1a shows a schematic representation of a medical X-ray imaging apparatus 100. The medical X-ray imaging apparatus 100 comprises an X-ray tube 105 having an anode 110. The anode 110 is pivotally supported within a rotational axis 115. An electron beam is emitted from an electron source (not depicted), whereby the electrons impinge onto a surface 111 of the anode within a focal spot 112. Due to limited focusing of the electron beam the focal spot 112 has a spatial enlargement.

An X-ray beam 117 is originating from the focal spot 112 and projecting along an optical axis 118. During normal operation of the medical X-ray imaging apparatus 100 the X-ray beam 117 penetrates at least partially through an object under examination (not depicted) and a flat X-ray detector 130 receives an image representing a two-dimensional X-ray attenuation profile. In this context it is clear that the larger the size of the focal spot 112 is, the larger is the unsharpness of the whole imaging apparatus 100.

In order to determine the size of the focal spot 112, a heavily X-ray absorbing edge device 120 having a sharp edge 121 is positioned within the X-ray beam 117 to a predetermined position along a moving direction indicated by the arrow 125. At that stationary position, a focus of finite size projects a shadow image of the absorbing edge device 120 onto the flat detector 130. Due to the finite size of the focal spot 112 the image of the edge 121 is smeared out such that a blurred image 131 of the edge 121 is generated on the X-ray sensitive surface of the detector 130. The size of the blurred image 131 not only depends on the size of the focal spot 112, the size of the blurred image 131 also strongly depends on the magnification factor, which is defined by the ratio between a distance 12 and a distance 11. Thereby, the distance 12 corresponds to the distance between the edge 121 and the detector 130. The distance 11 is the distance between the focal spot 112 and the edge 121.

When the edge device 120 is positioned in the X-ray beam 117, the distribution of X-ray intensity I impinging onto the detector 130 is measured. Thereby, an edge response profile 140 having a transitional region is recorded. Thereby, the intensity I is recorded as a function of the x-position of a detector element of the stationary X-ray detector 130. The edge response profile 140 is depicted in FIG. 1b. The shape of the transitional region contains information on blur due to the size of the focal spot 112.

FIG. 2a shows a diagram depicting edge response functions, which depict the intensity I as a function of the x-position of a detector element of the stationary X-ray detector. The measurement has been carried out at least three times such that a first edge response function 241a, a second edge response function 241b and a third edge response function 241c are recorded. These three edge response functions 241a, 241b, 241c may be averaged leading to a not depicted averaged edge response function, which by contrast to the initial edge response functions contains significant less statistic noise. Therefore, the accuracy of the focal blur measurement may be improved.

FIG. 2b shows a diagram depicting impulse functions, which have been obtained from the edge response functions depicted in FIG. 2a by differentiating the respective edge response functions. Therefore, a first impulse response function 246a, a second impulse response function 246b and a third edge response function 246c are obtained. Again, in order to improve the accuracy of the focal blur measurement method, an averaged impulse response function may be used for further processing.

FIG. 2c shows a diagram depicting modulation transfer functions (MFT), which have been obtained from the impulse response functions depicted in FIG. 2b by a Fourier Transformation. Thereby, a first modulation response function 251a, a second modulation response function 251b and a third modulation response function are obtained. The third modulation response function is not visible in FIG. 2c, because it is located just below the plots of the modulation response functions 251a and 251b. The MTF describes the contrast with an image plane as a function of the number of line pairs per millimeter. Therefore, the MTF is a direct measure for the spatial resolution, which, as has been described above, strongly depends on the size of the focal spot. This means that the extension of the focal spot along the x-axis can therefore be determined easily and precisely.

FIG. 3a shows an X-ray image 360 obtained at a predefined position of the edge device. With respect to an x-y coordinate system the edge of the edge device is slanted by an angle approximately of 45°. Thereby, the portion of the X-ray detector representing the upper right portion of the X-ray image is covered with the edge device such that none or only little X-radiation impinges onto the detector. By contrast thereto, the portion of the X-ray detector representing the lower left portion of the X-ray image 360 is not covered by the edge device. Therefore, this part of the X-ray image 360 appears dark. The deliberately slanted edge causes that an average edge response between the x-direction and the y-direction is determined.

FIG. 3b shows a further X-ray image 361. This image corresponds to the image 360, which however has been rotated by an angle of 45° by means of a known image processing algorithm.

FIG. 4 shows part of a beam-shaping device 470, which is used for manipulating an X-ray beam projecting perpendicular to the plane of drawing. First the beam-shaping device 470 is used for spatially shaping the X-ray beam. Thereby, movable baffles (not depicted) are provided in order to laterally restrict the cross section of the radiation beam. In case of a medical X-ray imaging the beam-shaping device is used to effectively limit the X-ray exposure to a defined region of a patient under examination, which region is subjected to an X-radiation dose. Second, the beam-shaping device 470 is used for removing or at least reducing the number of X-ray photons within the lower energy range of the whole X-ray energy distribution. In particular in medical X-ray imaging a removal of these low energy photons makes the whole X-ray imaging more effective because such low energy photons typically do not or do only weakly contribute to the X-ray imaging.

In order to provide for various spectral manipulations of the X-ray beam, the beam-shaping device 470 is equipped with various spectral filter elements, a fist filter element 481, a second filter element 482 and a third filter element 483. The filter elements 481, 482 and 483 are accommodated within a turret 475. The turret 475 is pivoted within a housing 471. The turret 475 may be rotated around a rotational axis 475a. A drive 477 comprising a gear wheel is provided in order to drive the rotational movement of the turret 475. Therefore, the outer circumference of the turret 475 is provided with a toothing 476, which engages with the toothing of the gear wheel 477.

The spectral beam-shaping is carried out by selectively inserting one of the filter elements 481, 482 and 483 into the X-ray beam, which projects out from a beam outlet 472. The filter elements 481, 482 and 483 are metal plates made from a combination of copper and aluminum. The thickness the aluminum layer with the plates is 1 mm. The Thickness of the copper layer is 0.1 mm, 0.4 mm and 0.9 mm for the filter element 481, the filter element 482 and the filter element 483, respectively. Of course, depending on the specific application the values of the plate thicknesses may also differ.

In normal use of the beam-shaping device 470, the filter elements 481, 482 and 483 are positioned such that they entirely cover the aperture 472 subtended by back-up shutters. For determining the focal spot size the edge 485 of the most heavily absorbing filter element 483 is rotated to a centre position. This angular position is controlled by reading out a shaft encoder, which encoder is coupled to the turret 475. Therefore, this position can be repeatedly adjusted in a reproducible manner.

In order to be able to carry out the method for determining the focal spot size as has been described above, one opening 478 of the turret 475 is not occupied by a filter element. Further, the opening 478 extends to the filter element 483, such that the edge 485 of the filter element 483 may be used for carrying out the described method. Thereby, the edge 485 is moved to a predefined position within the X-ray beam such that an edge response function can be recorded. The significance of the edge response function has already been described above in detail. The edge response function is used for calculating an impulse response function, which in turn represents a basis from which a modulation transfer function (MTF) can be obtained by applying a known Fourier Transform algorithm and taking the absolute value of the Fourier transform. As has also been described above, the MTF provides a high significance for the size of the focal spot from which the X-ray beam originates.

By contrast to known methods using a pinhole as a projection device and using the Fourier transform of the impulse response thereafter, the described method does not depend sensitively on a precise placing and aligning the projection device with respect to the optical axis. Therefore, the described method for determining the focal spot size has the advantage, that the method may be carried out in order to monitor the performance of an X-ray imaging system through time as a constancy test. This allows for an easy recognition, if due to any reason the focal spot of an X-ray tube changes during operation. In order to carry out a reliable monitoring of the focal spot size the described method has to be carried out frequently.

The provision of the filter element 483 representing the edge device within the beam-shaping device 470 has the advantage that no special hardware is necessary in order to carry out the described focal spot size determination. Therefore, the focal spot size determination can be implemented in standard X-ray imaging systems simply be means of a software modification. A further advantage of using the filter element 483 for the edge device is the fact, that the filter element 483 is typically arranged close to the X-ray tube. This means that the distance between the edge 485 and the focal spot is much smaller than the distance between the edge 485 and the X-ray detector. This has the advantage that a high magnification factor for recording the edge response function is realized allowing for a precise determination of the size of the focal spot.

At this point it has to be mentioned that of course the method for determining the focal spot size can also be realized with a translative movement of an edge into a predefined position within the beam.

FIG. 5 shows an example of an edge device 520 having two edges, a first edge 585a and a second edge 585b. The first edge 585a is oriented parallel to the x-axis, the second edge 585b is oriented parallel to the y-axis. By positioning the edge device 520 such that the second edge 585b is positioned within the X-ray beam 517, the edge response function along the x-axis can be measured. By positioning the edge device 520 such that the first edge 585a is positioned within the X-ray beam 517, the edge response function along the y-axis can be measured. Provided that an appropriate positioning system is available for moving the edge device 520, the focal spot size may be determined independently along the x- and the y-direction.

FIG. 6 shows a data processing device 690, which is adapted to control an X-ray imaging system in order to perform the above-described method for determining the spatial dimension of a focal spot size of an X-ray tube. The data processing device 690 comprises a central processing unit (CPU) 691. The CPU 691 is connected to a memory 692 for temporally storing acquired X-ray data and for storing at least on edge response function. Via a bus system 695 the CPU 691 is connected to a plurality of input/output network or diagnosis devices, such as a fluoroscopic X-ray imaging system, a computed tomography (CT) scanner or a C-arm system. Furthermore, the CPU 691 is connected to a display device 693, for example a computer monitor, for displaying information regarding the determined size and/or the shape of the focal spot. An operator or user may interact with the CPU 691 via a keyboard 694 and/or any other output devices, which are not depicted in FIG. 6.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

In order to recapitulate the above described embodiments of the present invention one can state:

It is described a method for measuring the sharpness in an X-ray system 100. The measurement is based on a common edge response. An edge device 120 representing the projection device is placed within a beam-shaping device 470. Due to a high geometrical magnification factor the edge response function 241a and also both an impulse response function 246a and a modulation transfer function 251a will predominately depend on the size of the focal spot 112 rather than on a pre-sampling spread function of a detector 130 being used for receiving the X-radiation 117, which has laterally passed the edge device 120.

### LIST OF REFERENCE SIGNS

100 medical X-ray imaging apparatus
105 X-ray tube
110 anode
111 anode surface
112 focal spot
115 rotation axis
117 X-ray beam
118 optical axis
120 edge device/filter element
121 edge
125 moving direction
130 flat X-ray detector
131 blurred image of edge 121
140 edge response profile
11 distance focal spot—edge
12 distance edge—detector
I Intensity
241a first edge response function
241a second edge response function
241b third edge response function
246a first impulse response function
246b second impulse response function
246c third impulse response function
251a first modulation transfer function
251b first modulation transfer function
360 X-ray image obtained by a deliberately slanted edge
361 rotated X-ray image 360
470 beam-shaping device
471 housing
472 beam outlet/aperture
475 turret
475a rotation axis
476 toothing
477 drive/gear wheel
478 opening
481 first filter element
482 second filter element
483 third filter element
485 edge
517 X-ray beam
520 edge device
585a first edge
585b second edge
690 data processing device
691 central processing unit
692 memory
693 display device
694 keyboard
695 bus system

1. A method for determining the spatial dimension of a focal spot (112) of an X-ray tube (105), which focal spot is generated by electrons impinging onto the surface (111) of an anode (110) of the X-ray tube (105), the method comprising the steps of
generating an X-ray beam (117) originating from the focal spot (112),
moving an X-ray attenuating edge device (120) into the X-ray beam (117) to a predetermined position,
measuring an edge response function (241a) based on a shadowing effect of the edge device (120) by means of an X-ray detector (130) having a spatial resolution, and
analyzing the edge response function (241a),
wherein
the edge device (120) is located within an X-ray beam-shaping device (470), which beam-shaping device (470) is associated with the X-ray tube (105).

2. The method according to claim 1, wherein
the X-ray detector is a two-dimensional detector (130).

3. The method according to claim 2, wherein
the step of measuring an edge response function (241a) comprises
recording the total intensity of X-rays (117) impinging onto at least a plurality of pixel elements of the X-ray detector by integrating the signals of these pixel elements.

4. The method according to claim 3, further comprising
calculating an impulse response function (246a) representing the derivative of the edge response function (241a).

5. The method according to claim 4, further comprising
calculating a modulation transfer function (251a) representing the Fourier transform of the impulse response function (246a).

6. The method according to claim 1, further comprising
again moving the X-ray attenuating edge device (120) into the X-ray beam (117) to a further predetermined position,
measuring a further edge response (241b) by means of the X-ray detector (130).

7. The method according to claim 1, wherein
the beam-shaping device (470) is adapted to laterally limit the dimension of the X-ray beam (117).

8. The method according to claim 1, wherein
the beam-shaping device (470) is adapted to modify the spectral distribution of the X-ray beam (117) being emitted from the X-ray tube (105).

9. The method according to claim 8, wherein
the edge device (120) is a spectral filter element (483).

10. The method according to claim 1, wherein
the edge device (483) is accommodated or attached to a turret (475).

11. The method according to claim 1, wherein
the edge device (520) comprises a first edge (585a) and a second edge (585b), wherein the first edge (585a) is oriented slanted with respect to the second edge (585b).

12. A data processing device
for determining the spatial dimension of a focal spot (112) of an X-ray tube (105),
the data processing device (690) comprising
a data processor (691), which is adapted for performing the method as set forth in claim 1, and
a memory (692) for storing at least one edge response function.

13. Medical X-ray imaging apparatus, in particular a computed tomography scanner or a C-arm system, the medical X-ray imaging apparatus (100) comprising
a data processing device (690) according to claim 12.

14. A computer-readable medium on which there is stored a computer program
for determining the spatial dimension of a focal spot (112) of an X-ray tube (105), the computer program,
when being executed by a data processor (691), is adapted for performing the method as set forth in claim 1.

15. A program element
for determining the spatial dimension of a focal spot (112) of an X-ray tube (105), the program element,
when being executed by a data processor (691), is adapted for performing the method as set forth in claim 1.
